(19) United States
(12) Patent Application Publication
(10) Pub. No.: US 2017/0316371 A1
(43) Pub. Date: Nov. 2, 2017

(54) STOCKING LEVEL INDICATION APPARATUS AND METHOD

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/498,574

(22) Filed: Apr. 27, 2017

Related U.S. Application Data
(60) Provisional application No. 62/329,445, filed on Apr. 29, 2016.

(51) Int. Cl. G06Q 10/08; G08B 5/22; H04N 7/18; F15B 15/10

(52) U.S. Cl. CPC G06Q 10/087; H04N 7/185; G08B 5/22; F15B 15/10

(57) ABSTRACT

In some embodiments, systems, apparatuses, and methods are described herein to provide a visual indication of a level or number of products stocked on a shelf of a shelving unit. The visual indication is provided by virtue of an accumulated weight of products on the shelf causing an indicator device to visually change according to the weight.

### CROSS-REFERENCE TO RELATED APPLICATIONS

This application claims the benefit of U.S. Provisional Application No. 62/329,445, filed Apr. 29, 2016, which is hereby incorporated by reference herein in its entirety.

### TECHNICAL FIELD

This invention relates generally to retail shelving and, more particularly, to stocking level indicating shelving assemblies.

### BACKGROUND

Retail stores often utilize modular shelving units to display products for sale. It can be important to maintain an accurate count of inventory during operation of the store. Pursuant to this, associates often have to count products on the shelves. It can be difficult for associates to accurately determine a count of products on the shelves and, as such, one method to ensure an accurate count to remove all of the products from the shelves. Unfortunately, the associates must then restock the products on the shelves.

### BRIEF DESCRIPTION OF THE DRAWINGS

Disclosed herein are embodiments of systems, apparatuses and methods pertaining to a shelving assembly that provides an indication of a stocking level of products on the shelving assembly. This description includes drawings, wherein:

FIG. 1 is a perspective view of a shelving unit in accordance with some embodiments.

FIG. 2 is a schematic side elevational view of a first stocking level indication assembly in accordance with several embodiments.

FIG. 3 is a schematic side elevational view of a second stocking level indication assembly in accordance with some embodiments.

FIG. 4 is a flowchart in accordance with several embodiments.

FIG. 5 is a flowchart in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to provide a visual indication of a level or number of products stocked on a shelf of a shelving unit. The visual indication is provided by virtue of an accumulated weight of products on the shelf causing an indicator device to visually change according to the weight. More specifically, a shelf assembly is described herein that utilizes the accumulated weight of products to operate a pressure-driven indicator. The indicator can be mounted to the shelving unit so as to be visible to an associate and, as such, an associate trying to determine whether a particular shelf needs to be restocked, can avoid having to manipulate or remove products from a shelf to determine a current stock level.

By some approaches, a shelving assembly as described herein utilizes a bladder or other fluid containment member. When products are stocked on the shelf assembly, the weight of the products presses down on the bladder. The pressure-driven indicator can advantageously be fluidly connected to the bladder so that the pressure created within the bladder as a result of the stocked products is visually indicated. Utilizing the indicator and the type of product stocked on the shelf, including an approximate weight thereof, an approximate number of products on the shelf can be extrapolated, such as by a control circuit analyzing an image of the assembly and the indicator thereof.

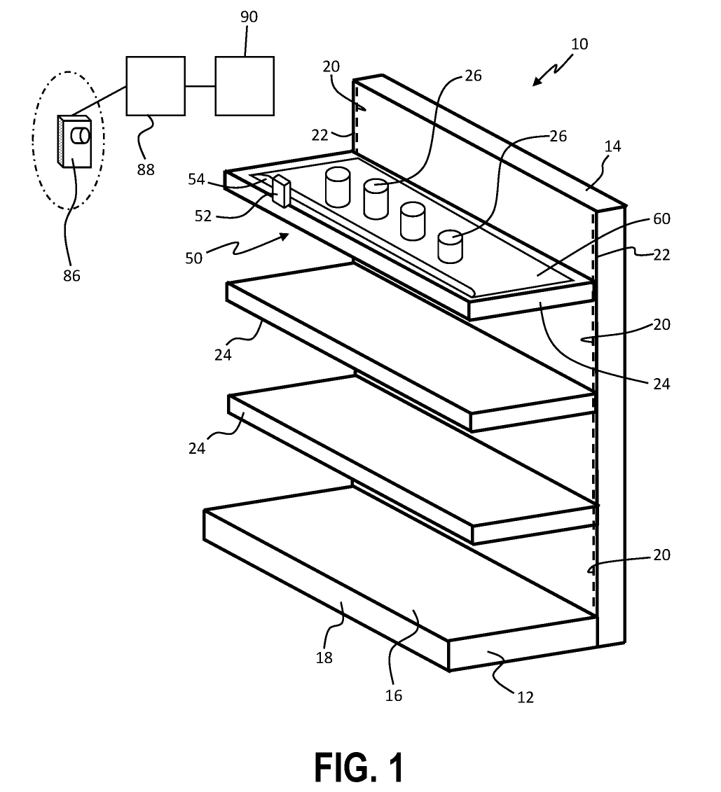

An example shelving unit 10 is shown in FIG. 1. Based on a particular use, multiple shelving units 10 can be aligned in a row to produce an aisle in a retail location. The shelving unit 10 includes a base portion 12 and a back wall 14 extending upwardly therefrom. The base portion 12 can include a base deck 16 and a kick plate 18, as commonly configured. A plurality of shelf notches 20 are vertically disposed adjacent to lateral edges 22 of the back wall 14 to provide anchor points for shelves 24 mounted to the shelving unit 10. After the shelving unit 10 is assembled, associates can then stock products 26 on the shelves 24.

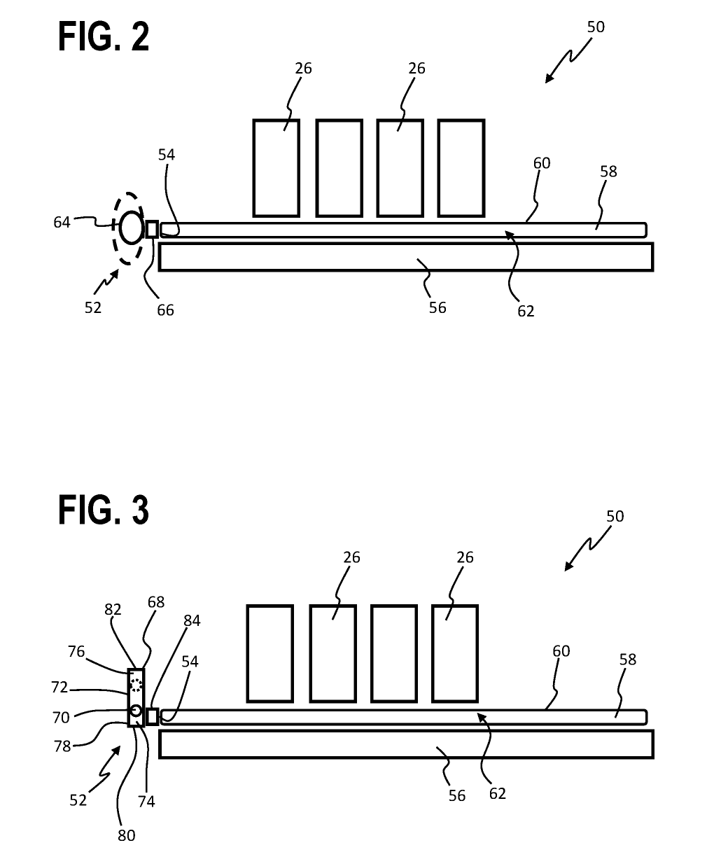

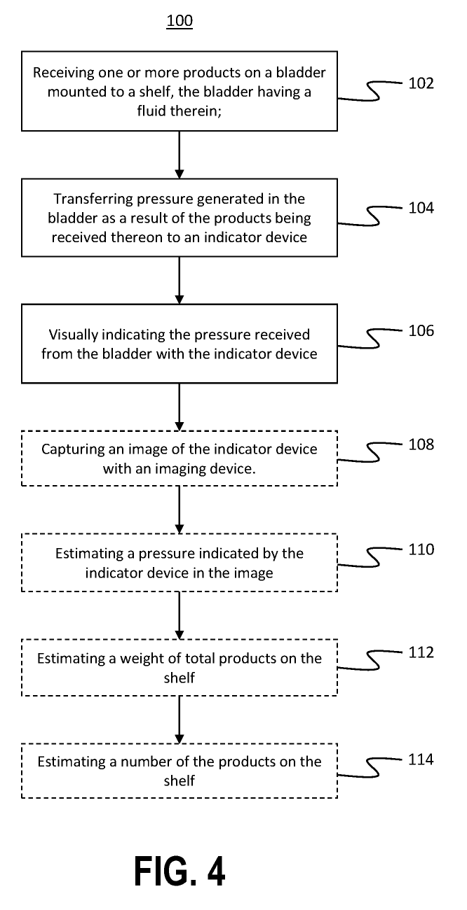

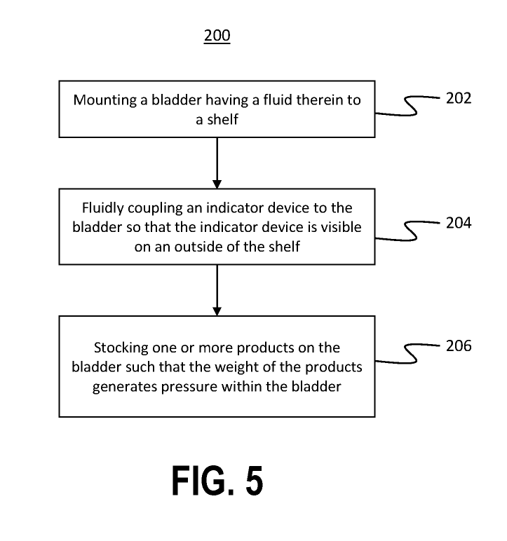

If desired, as shown in FIGS. 2 and 3, one or more of the shelves 24 can include a stocking level indication assembly 50. As shown, the assembly 50 includes an indicator device 52 disposed on an edge portion 54 thereof so as to be visible to an associate checking stock levels. The assembly 50 includes a rigid lower wall portion 56, an intermediate bladder portion 58, and a rigid or semi-rigid upper wall portion 60. Further, the bladder 58 has a flowable fluid 62 disposed therein, which can be any suitable gas or liquid. So configured, as products 26 are placed on the assembly 50 the upper wall portion 60 causes the fluid 62 to be compressed in a generally uniform manner. The indicator 52 is fluidly coupled to the bladder 58 so that pressure created in the bladder 58 causes a visual change in the indicator 52.

By some approaches, the assembly 50 can be an insert configured to be placed on an existing shelf 24. By other approaches, the assembly 50 can be a retrofit shelf 24, configured to replace a traditional shelf 24 and mount to the shelving unit back wall 14.

In one form, the lower wall portion 56 is a rigid shelving member and the bladder 58 is mounted to the shelving member 56. The bladder 58 can be mounted to the shelving member 56 using an adhesive, hardware, or any other suitable method. By some approaches, the upper wall portion 60 can be the upper wall portion of the bladder 58. By other approaches, the upper wall portion 60 can be a separate wall member mounted to the bladder 58, using one of the methods discussed above.

Example indicators 52 are shown in FIGS. 2 and 3. In one form, the indicator 52 is a balloon or inflatable member 64. The balloon 64 is sealingly and fluidly coupled to the bladder 58 using a gasket or other suitable mechanism 66. The balloon 64 can be of a material that is relatively more elastic and/or less rigid than the material of the bladder 58. With this configuration, the indicator 52 will have a baseline, smaller size when there are no products 26 on the assembly 50. Then, as products 26 are placed on the assembly, the balloon 64 sequentially gets larger as pressure is increased in the bladder. As such, the size of the balloon 64 provides a visual indication of the stocking level on the assembly 50.

In another form, the indicator 52 can be a gauge 68 having a pressure-indicating member 70 that is shifted when the gauge 68 receives a change in pressure. By one approach, the gauge 68 can include a housing 72 with a hollow interior 74, such as a tube as shown, with an interior cross-section. The pressure-indicating member 70 can have a cross-section generally equal to the internal cross-section of the hollow interior 74. For example, as shown, the hollow interior 74 can be generally circular and the pressure-indicating member 70 can be a sphere. Although a circular cross-section is shown, other suitable shapes can be utilized. So configured, the hollow interior 74 is divided into first and second pressure portions 76, 78 with the pressure-indicating member 70 disposed therebetween.

With this configuration, the first portion 76 can be loaded with a predetermined pressure and the second portion 78 can be fluidly connected with the bladder 58. As such, in a baseline state with no products 26 on the assembly 50, the pressure within the first portion 76 will push the pressure-indicating member 70 to one end 80 of the housing 72. Then, as products 26 are loaded on the assembly 50, the pressure within the second portion 78 will be increased, which will shift the pressure-indicating member 70 within the housing 72 towards a second end 82 thereof If desired, the predetermined pressure within the first portion 76 can be customized to a particular product 26 intended for the assembly. For example, if the intended products 26 are relatively heavy, the pressure within the first portion 76 can be increased, and vice versa. As with the above form, the gauge 68 can be sealingly and fluidly coupled to the bladder 58 using a gasket or other suitable mechanism 84.

By another approach, the gauge 68 can be a dial-type gauge where the pressure-indicating member 70 is pivotably mounted within the housing 72. So configured, as pressure is increased from a supply coupled to the gauge 68, the pressure-indicating member 70 pivots within the housing 72 to indicate a current pressure. As with the above form, the gauge 68 of this form can be coupled to the bladder 58 using the gasket or other suitable mechanism 84.

As shown in FIG. 1, an imaging device 86, such as a camera or the like, can be mounted adjacent to the assembly 50 to capture an image thereof, such as closely proximate thereto. The imaging device 86 can be mounted to a fixed location, such as the shelving unit 10 itself, including to one of the shelves 24, a wall of the retail location, or other structure. In another form, the imaging device 86 can be mounted to a mobile structure, such as a cart, robot, or the like. For example, the imaging device 86 can be configured to operate as a shopper moves a cart around the store or as a robot is programmed to move up and down aisles in the store. Regardless of the mounting location, the imaging device 86 can be oriented and configured to capture an image of the assembly 50, and specifically the indicator 52 thereof.

Thereafter, the imaging device 86 can send the image to a computing device 88 having a control circuit therein over a wired connection or over any suitable network, utilizing radio communication, Bluetooth, WiFi, near field communication, or the like utilizing any suitable receivers, transmitters, transceivers, or the like. The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 88 may be configured (for example, by using corresponding programming stored in a memory as will be well understood by those skilled in the art) to carry out one or more of the steps, actions, and/or functions described herein.

The control circuit 88 receives the image and is configured to estimate a pressure indicated by the indicator 52. By a first approach, the control circuit 88 can receive an image showing the assembly 50 without any products 26 disposed thereon so that the control circuit 88 can use the image and the indicator 52 shown therein as a baseline scale for future images and measurements. By a further approach, the control circuit can receive an image showing the assembly 50 in a fully stocked configuration so that the control circuit 88 can use the image and the indicator 52 shown therein as a top of the scale. Accordingly, subsequently images can be compared within the set scale to determine an approximate percentage of stock level.

In one example utilizing the balloon 64, the control circuit 88 can be configured to estimate a size of the balloon 64 and correlate the size to an estimated pressure, such as by referencing the scale or by referencing a table or the like. In another example utilizing the gauge 68, the control circuit 88 can be configured to estimate a location of the pressure-indicating member 70 within the housing 72 and correlate the location to an estimated pressure, which can include revising for a particular predetermined pressure in the first portion 76. The location of the pressure-indicating member 70 can also or alternatively be compared to the baseline image to determine an amount of deflection. Next, the control circuit 88 can be configured to estimate a total weight of products 26 on the assembly 50 based on the estimated pressure.

The control circuit 88 can further be configured to access product location information, stored locally or on a remote database or server device 90. The product location information can identify the products 26 intended to be stocked on the assembly 50 and identify weight data of the identified products 26. From the weight of the products 26 that are intended to be stocked on the assembly 50 and the estimated weight, the control circuit 96 can estimate a number of products 26 on the assembly 50.

If desired, the control circuit 88 can further compare the estimated number of products 26 on the assembly 50 and compare it to a predetermined stock number, such as a number that would indicate a low stock level. In response to determining that the estimated number is at or below the predetermined stock number, the control circuit 88 can be configured to send out a low stock signal. The low stock signal can be sent or routed to any suitable recipients, such as to create tasks therefor, including devices for stocking associates, devices for ordering additional stock, and the like.

Additionally, the estimated weight and/or estimated number of products can be used by the control circuit 88 to generate warning signals. For example, if the estimates indicate that there is too much weight on the assembly 50, the control circuit 88 can be configured to send out a warning signal to suitable recipients to remove products 26 from the assembly 50. Moreover, if the estimates indicate an anomaly, such as a weight or number that do not reflect the products intended to be stocked on the assembly 50, the control circuit 88 can be configured to send a warning signal to suitable recipients to check the shelving unit 14.

In some embodiments, a stock level indication assembly is described herein that includes a shelf, a bladder mounted to the shelf and having a fluid therein, and an indicator device fluidly coupled to the bladder. The assembly further includes one or more products disposed on the bladder such that weight of the products generates pressure in the indicator device to provide a visual indication of the number of products stocked on the shelf.

By several approaches, the indicator device can include a tube with an indicator member disposed therein. The tube can have a predetermined pressure on one side of the indicator member and a pressure from the bladder on the other side of the indicator member such that the position of the indicator member within the tube provides a visual indication of the products disposed on the bladder.

By some approaches, the indicator device is a balloon. As such, the bladder can be of a first material and the balloon can be of a second material, where the second material is less rigid or more elastic than the first material.

By further approaches, the stock level indication assembly can further include an imaging device oriented and configured to capture an image of the indicator device. The stock level indication assembly can further include a control circuit operably coupled to the imaging device and configured to receive the image therefrom. The control circuit can be configured to estimate a pressure indicated by the indicator device in the image, estimate a weight of total products on the shelf based on the estimated pressure, access product location information, and estimate a number of the products on the shelf based on the product location information and the estimated weight.

In several embodiments, a method 100 for providing a visual indication of stock level is described herein that includes receiving 102 one or more products on a bladder mounted to a shelf, the bladder having a fluid therein, transferring 104 pressure generated in the bladder as a result of the products being received thereon to an indicator device, and visually indicating 106 the pressure received from the bladder with the indicator device.

By some approaches, visually indicating 106 the pressure received from the bladder with the indicator device can include moving an indicator member within a tube. The tube of these approaches can have a predetermined pressure on one side of the indicator member and the pressure received from the bladder on the other side of the indicator member.

By several approaches, visually indicating 106 the pressure received from the bladder with the indicator device can include expanding a balloon. The bladder can be of a first material and the balloon can be of a second material, where the second material is less rigid or more elastic than the first material.

By some approaches, the method can further include capturing 108 an image of the indicator device with an imaging device. In further approaches, the method can include receiving the image at a control circuit from the imaging device and estimating 110 a pressure indicated by the indicator device in the image with the control circuit. In yet further approaches, the method can include estimating 112 a weight of total products on the shelf based on the estimated pressure with the control circuit, accessing product location information, and estimating 114 a number of the products on the shelf with the control circuit based on the product location information and the estimated weight.

In some embodiments, a method 200 for installing a stock level indication assembly is described herein that includes mounting 202 a bladder having a fluid therein to a shelf, fluidly coupling 204 an indicator device to the bladder so that the indicator device is visible on an outside of the shelf, and stocking 206 one or more products on the bladder such that the weight of the products generates pressure within the bladder, which is transferred to the indicator device such that the indicator device provides a visual indication of the number of products stocked on the shelf.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A stock level indication assembly for a retail product storage structure, the stock level indication assembly comprising:
a shelf;
a bladder mounted to the shelf and having a fluid therein;
an indicator device fluidly coupled to the bladder;
one or more products disposed on the bladder such that weight of the products generates pressure in the indicator device to provide a visual indication of the number of products stocked on the shelf.

2. The stock level indication assembly of claim 1, wherein a top surface of the bladder is rigid or semi-rigid.

3. The stock level indication assembly of claim 1, wherein the bladder is disposed within the shelf.

4. The stock level indication assembly of claim 1, wherein the bladder is adhered to a top surface of the shelf.

5. The stock level indication assembly of claim 1, wherein the indicator device comprises a tube with an indicator member disposed therein, the tube having a predetermined pressure on one side of the indicator member and a pressure from the bladder on the other side of the indicator member such that the position of the indicator member within the tube provides a visual indication of the products disposed on the bladder.

6. The stock level indication assembly of claim 1, wherein the bladder is of a first material and the indicator device comprises a balloon of a second material, the second material being less rigid or more elastic than the first material.

7. The stock level indication assembly of claim 1, further comprising an imaging device oriented and configured to capture an image of the indicator device.

8. The stock level indication assembly of claim 8, wherein the imaging device is mounted to a mobile assembly.

9. The stock level indication assembly of claim 8, further comprising a control circuit operably coupled to the imaging device and configured to receive the image therefrom, the control circuit configured to estimate a pressure indicated by the indicator device in the image, estimate a weight of total products on the shelf based on the estimated pressure, access product location information, and estimate a number of the products on the shelf based on the product location information and the estimated weight.

10. The stock level indication assembly of claim 9, wherein the control circuit is further configured to send a low stock signal or message in response to determining that the number of the products estimated to be on the shelf is at or below a predetermined number.

11. A method for providing a visual indication of stock level on retail product storage structure, the method comprising:
receiving one or more products on a bladder mounted to a shelf, the bladder having a fluid therein;
transferring pressure generated in the bladder as a result of the products being received thereon to an indicator device;
visually indicating the pressure received from the bladder with the indicator device.

12. The method of claim 11, wherein visually indicating the pressure received from the bladder with the indicator device comprises moving an indicator member within a tube, the tube having a predetermined pressure on one side of the indicator member and the pressure received from the bladder on the other side of the indicator member.

13. The method of claim 11, wherein visually indicating the pressure received from the bladder with the indicator device comprises expanding a balloon, the bladder being of a first material and the balloon being of a second material, the second material being less rigid or more elastic than the first material.

14. The method of claim 11, further comprising capturing an image of the indicator device with an imaging device.

15. The method of claim 14, further comprising:
receiving the image at a control circuit from the imaging device; and
estimating a pressure indicated by the indicator device in the image with the control circuit.

16. The method of claim 15, further comprising:
estimating a weight of total products on the shelf based on the estimated pressure with the control circuit;
accessing product location information; and
estimating a number of the products on the shelf with the control circuit based on the product location information and the estimated weight.

17. The method of claim 16, further comprising sending a low stock signal or message with the control circuit in response to determining that the number of the products estimated to be on the shelf is at or below a predetermined number.

18. A method for installing a stock level indication assembly for a retail product storage structure, the method comprising:
mounting a bladder having a fluid therein to a shelf;
fluidly coupling an indicator device to the bladder so that the indicator device is visible on an outside of the shelf;
stocking one or more products on the bladder such that the weight of the products generates pressure within the bladder, which is transferred to the indicator device such that the indicator device provides a visual indication of the number of products stocked on the shelf.
